(19) United States
(12) Patent Application Publication
(10) Pub. No.: US 2025/0046808 A1
(43) Pub. Date: Feb. 6, 2025

(54) METHOD FOR MANUFACTURING POSITIVE ELECTRODE ACTIVE MATERIAL

(71) Applicant: Prime Planet Energy & Solutions, Inc., Tokyo (JP)

(72) Inventor: Shinya SUZUKI, Kobe-shi (JP)

(21) Appl. No.: 18/789,683

(22) Filed: Jul. 31, 2024

(30) Foreign Application Priority Data
Aug. 3, 2023 (JP) 2023-126808

(51) Int. Cl. H01M 4/525; C01G 53/00; H01M 4/02

(52) U.S. Cl. CPC H01M 4/525; C01G 53/006; C01G 53/44; C01P 2002/50; C01P 2006/40; H01M 2004/028

(57) ABSTRACT

According to the present disclosure, a method for manufacturing a positive electrode active material that can contribute to improvement of battery performance. The manufacture method disclosed herein includes: a preparation step S10 of preparing a starting raw material containing at least a transition metal element; a formulation step S20 of formulating a transition metal solution by dissolving, in an extractant, the transition metal element in the starting raw material; a precursor production step S30 of crystallizing a positive electrode active material precursor by adding an alkali solution to the transition metal solution; and an active material production step S40 of producing a positive electrode active material by heating the positive electrode active material precursor together with a lithium compound. In the manufacture method disclosed herein is characterized in that a sulfate ion concentration of the transition metal solution is 0.9 mol/L or lower during the precursor production step.

### CROSS REFERENCE TO RELATED APPLICATION

This application claims priority based on Japanese Patent Application No. 2023-126808 filed Aug. 3, 2023, the entirety of which is herein incorporated by reference.

### BACKGROUND OF THE DISCLOSURE

### 1. Field

The technology disclosed herein relates to a method for manufacturing a positive electrode active material. Specifically, the technology disclosed herein relates to a method for manufacturing a positive electrode active material for a lithium ion secondary battery.

### 2. Background

Lithium ion secondary batteries are widely used in various appliances such as mobile terminals and vehicles. For the positive electrode active material in lithium ion secondary batteries, e.g. a lithium transition metal composite oxide is used. Examples of the transition metals contained in the lithium transition metal composite oxide include Ni, Co, and Mn.

WO 2018/123995 discloses an example of a precursor for this type of positive electrode active material (lithium transition metal composite oxide). As described in this patent literature 1, in the production of positive electrode active materials, a transition metal sulfate (NiSO₄, CoSO₄, MnSO₄, etc.) is normally prepared as a starting raw material. Next, this sulfate is dissolved in water to formulate a mixed aqueous solution (transition metal solution). Then, an alkali solution (NaOH etc.) is added to this transition metal solution to precipitate a compound containing a transition metal (positive electrode active material precursor). The positive electrode active material precursor is mixed with the lithium compound and baked to produce a lithium transition metal composite oxide.

### SUMMARY

In recent years, requirements for high performance of lithium ion secondary batteries have further increased. The technology disclosed herein has been made in response to such requirements, and an object of the present invention is to provide a method for manufacturing a positive electrode active material that can contribute to improvement of battery performance.

To resolve the above-described problem, a method for manufacturing a positive electrode active material (hereinafter simply referred to as the “manufacture method”) configured as described below.

The method for producing the positive electrode active material disclosed herein includes: preparing a starting raw material containing at least a transition metal element; formulating a transition metal solution by dissolving, in an extractant, the transition metal element in the starting raw material; crystallizing a positive electrode active material precursor by adding an alkali solution to the transition metal solution; and producing a positive electrode active material by heating the positive electrode active material precursor together with a lithium compound. The production method disclosed herein is characterized in that a sulfate ion concentration of the transition metal solution is 0.9 mol/L or lower during the crystallizing a positive electrode active material precursor.

As described above, in a general production of a positive electrode active material, a transition metal sulfate (NiSO4, CoSO4, MnSO4, etc.) is used as a starting raw material. For this reason, sulfates such as sodium sulfate (Na₂SO₄) contaminate the manufactured positive electrode active material in some cases. As a result of investigation, the present inventors have found that an initial resistance of a lithium ion secondary battery increases as the sulfate contamination level in the positive electrode active material increases. The manufacture method disclosed herein is based on this finding. Specifically, in the manufacture method disclosed herein, a sulfate ion (SO₄²⁻) concentration of the transition metal solution during the crystallizing a positive electrode active material precursor is 0.9 mol/L or lower. Thereby, the sulfate contamination level in the manufactured positive electrode active material can be decreased, contributing to lowering of the initial resistance of the lithium ion secondary battery.

### BRIEF DESCRIPTION OF THE DRAWINGS

FIG. 1 is a flowchart illustrating a method for manufacturing a positive electrode active material according to the first embodiment; and

FIG. 2 is a flowchart illustrating a preparation step according to another embodiment.

### DETAILED DESCRIPTION OF THE PREFERRED EMBODIMENTS

Hereinafter, an embodiment of a technology disclosed herein will be explained with reference to the figures. Matters other than those specifically mentioned in this specification, which are necessary for implementing the technology disclosed herein may be understood as design matters for those skilled in the art, based on the prior art in the field. The technology disclosed herein can be implemented based on the contents disclosed in this specification and the general technical knowledge in the field. In this specification, the notation “A to B” indicating a range encompasses a meaning of “A or more and B or less”, as well as meanings of “preferably more than A” and “preferably less than B”.

### First Embodiment

The first embodiment of the manufacturing method disclosed herein will be explained below. After the positive electrode active material to be manufactured is explained, the specific procedure of the manufacture method according to the first embodiment is explained.

### [Positive Electrode Active Material]

In the manufacture method according to the first embodiment, a lithium transition metal composite oxide for use as a positive electrode active material of a lithium ion secondary battery is manufactured. This lithium transition metal composite oxide is an oxide containing lithium (Li) and transition metal elements. Examples of the transition metal elements herein include nickel (Ni), cobalt (Co), and manganese (Mn). Examples of this lithium transition metal composite oxide include a lithium-nickel composite oxide (LN oxide), a lithium-cobalt composite oxide (LC oxide), a lithium-nickel-manganese composite oxide (LNM oxide), a lithium-manganese-cobalt composite oxide (LMC oxide), a lithium-nickel-cobalt composite oxide (LNC oxide), and a lithium-nickel-cobalt-manganese composite oxide (LNCM oxide). These lithium transition metal composite oxides may contain Li and elements other than transition metal elements (additive elements). Examples of the additive elements include Mg, Ca, Al, Ti, V, Cr, Si, Y, Zr, Nb, Mo, Hf, Ta, W, Na, Fe, Zn, Sn, B, C, Si, P, S, F, Cl, Br, and I.

As described later in detail, the manufacture method according to the first embodiment makes it possible to decrease the sulfate contamination level in the manufactured positive electrode active material. Specifically, the manufacture method according to the first embodiment makes it possible to decrease a sulfur ion (SO₄²⁻) content in the positive electrode active material to 1.2 wt % or less (preferably 0.9 wt % or less, more preferably 0.6 wt % or less, and particularly preferably 0.3 wt % or less) to lower the initial resistance of the lithium ion secondary battery. Note that the “sulfur ion (SO₄²⁻) content” herein is a value calculated based on a result of a high-frequency inductively coupled plasma (ICP) measurement. Specifically, a weight (wt %) of sulfur element (S) in the positive electrode active material can be measured by using ICP. In terms of the composition of sulfur ion (SO₄²⁻), a content of sulfur ion can be calculated based on the weight of sulfur element.

### [Method for Manufacturing Battery Material]

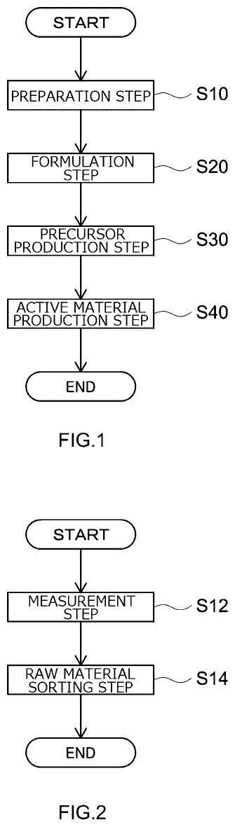

Next, the method for manufacturing the positive electrode active material according to the first embodiment will be explained. FIG. 1 is a flowchart illustrating a method for manufacturing a positive electrode active material according to the first embodiment.

As illustrated in FIG. 1, the method for manufacturing the battery material according to the first embodiment includes a preparation step S10, a formulation step S20, a precursor production step S30, and an active material production step S40. Each step will be explained below with reference to a case where an LNCM oxide is manufactured as a positive electrode active material as an example.

### (1) Preparation Step S10

In the preparation step S10, a starting raw material containing at least transition metal elements is prepared. As described below in detail, the starting raw material can be selected as appropriate from conventionally known raw materials depending on a composition of an object to be manufactured (positive electrode active material). For example, in the first embodiment, an LNCM oxide containing Ni, Co, and Mn as transition metal elements is manufactured. In this case, a starting raw material containing Ni, Co, and Mn is prepared in this step. One type or multiple types of starting raw materials may be prepared in this step. Specifically, one type of starting raw material that can provide all necessary transition metal elements may be prepared. Alternatively, multiple types of starting raw materials may be prepared to provide necessary transition metal elements depending on a combination of the multiple types of starting raw materials. For example, in the first embodiment, a starting raw material containing Ni and Co (NiCo source) and a starting raw material containing Mn (Mn source) are separately prepared to provide Ni, Co, and Mn required for manufacturing the LNCM oxide. The NiCo source in the first embodiment is prepared by baking a positive electrode active material (LNCM oxide) of a used lithium ion secondary battery. On the other hand, manganese chloride (MnCl₂) is used as the Mn source.

### (2) Formulation Step S20

In the formulation step S20, the transition metal elements in the starting raw material are dissolved in an extractant to formulate a transition metal solution. In this step, any conventionally known procedure can be adopted without any particular limitation as long as the transition metal solution containing desired transition metal elements can be formulated. In the first embodiment, an NiCo raw material (baked LNCM oxide) is first immersed in ammonia water. Thereby, nickel oxide (NiO) and cobalt oxide (CoO) in the baked LNCM oxide exude into the ammonia water to obtain a solution containing Ni and Co elements (NiCo solution). On the other hand, manganese oxide (MnO) in the baked LNCM oxide is difficult to exude into ammonia water. Thus, in the first embodiment, manganese chloride is separately prepared as an Mn source. Then, this manganese chloride can be dissolved in another extractant (such as water) to formulate a solution containing Mn element (Mn solution). Subsequently, this Mn solution is added to the NiCo solution to formulate a transition metal solution containing Ni, Co, and Mn (NiCoMn solution).

The metal concentration of the transition metal solution is preferably 1.0 mol/L or higher, more preferably 1.2 mol/L or higher, even more preferably 1.4 mol/L or higher, particularly preferably 1.5 mol/L or higher. Thereby, a positive electrode active material precursor can be efficiently crystallized in the precursor production step S30. On the other hand, if the metal concentration of the transition metal solution is too high, the solubility of the metal approaches a saturated solubility, and therefore the metal may precipitate due to a slight change in temperature. In this regard, the metal concentration of the transition metal solution is preferably 2.6 mol/L or lower, more preferably 2.4 mol/L or lower, even more preferably 2.2 mol/L or lower, particularly preferably 2 mol/L or lower. A mixing ratio of the transition metal elements (Ni, Co, Mn, etc.) in the transition metal solution is adjusted as appropriate depending on the composition of the positive electrode active material to be manufactured.

In this step, a reducing agent and a pH buffer may be added to the extractant to facilitate extraction of Ni and Co elements. As the reducing agent, hydrogen peroxide water or the like may be suitably used. As the pH buffer, ammonium sulfate or the like can be suitably used. When ammonium sulfate is used as the pH buffer, it is preferable to adjust the addition amount of the pH buffer so that the sulfate ion concentration of the transition metal solution is 0.9 mol/L or lower, as described below.

### (3) Precursor Production Step S30

In the precursor production step S30, an alkali solution is added to the transition metal solution to crystallize the positive electrode active material precursor. In this step, any conventionally known crystallization treatment may be adopted without any particular limitation as long as the positive electrode active material precursor can be produced. Examples of the alkali solution include an ammonia (NH₃) aqueous solution, a sodium hydroxide (NaOH) aqueous solution, and a potassium hydroxide (KOH) aqueous solution. In the first embodiment, an NaOH aqueous solution is added to the above-described transition metal solution (NiCoMn solution) to control the pH of the transition metal solution to be strongly alkaline (pH=11 or higher). Thereby, an NiCoMn hydroxide is crystallized in the transition metal solution. The NiCoMn hydroxide can be collected by solid-liquid separation. Subsequently, the NiCoMn hydroxide is washed with water or the like and then dried to obtain a dried NiCoMn hydroxide (positive electrode active material precursor).

### (4) Active Material Production Step S40

In the active material generation step S40, the positive electrode active material precursor is heated together with a lithium compound to produce a positive electrode active material. In the first embodiment, the positive electrode active material precursor (NiCoMn hydroxide) and the lithium compound (Li₂CO₃, LiOH, etc.) are mixed. The mixing ratio herein is adjusted as appropriate depending on the composition of the positive electrode active material to be manufactured. Then, the mixture can be baked under oxygen atmosphere to manufacture a positive electrode active material (LNCM oxide) for a lithium ion secondary battery.

The maximum temperature in the baking treatment is preferably 700° C. or higher, more preferably 725° C. or higher, even more preferably 750° C. or higher, particularly preferably 775° C. or higher. Thereby, the positive electrode active material precursor and the lithium compound can be properly reacted to efficiently produce the positive electrode active material precursor. On the other hand, a too high maximum temperature causes degradation of battery characteristics due to an excessive crystal growth. In this regard, the maximum temperature in the baking treatment is preferably 900° C. or lower, more preferably 875° C. or lower, even more preferably 850° C. or lower, particularly preferably 825° C. or lower. The baking time is preferably 3 hours or longer, more preferably 3.5 hours or longer, even more preferably 4 hours or longer, particularly preferably 4.5 hours or longer. Thereby, the positive electrode active material precursor and the lithium compound can be sufficiently reacted. On the other hand, the upper limit of the baking time may be, but is not particularly limited to, 7 hours or shorter, 6.5 hours or shorter, 6 hours or shorter, or 5.5 or shorter. The “baking time” in this specification refers to a time required for maintaining the maximum temperature.

### (5) Control of Sulfate Ion

The manufacture method disclosed herein is characterized in that the sulfate ion concentration of the transition metal solution during the crystallizing a positive electrode active material precursor is 0.9 mol/L or lower. From an experiment conducted by the present inventors, it has been confirmed that a sulfate contamination level in the manufactured positive electrode active material can be decreased by using such a transition metal solution with a low sulfate ion concentration. Furthermore, the initial resistance of the lithium ion secondary battery can be lowered by using this positive electrode active material.

Here, in the manufacture method according to the first embodiment, a starting raw material substantially free from sulfur element is used. Thereby, the sulfate ion concentration of the transition metal solution can be controlled to 0.9 mol/L or lower. Specifically, in the first embodiment, a used positive electrode active material (LNCM oxide) is used as the NiCo source. This used positive electrode active material is substantially free from sulfur element unlike nickel sulfate (NiSO₄) that is a conventional Ni source and cobalt sulfate (CoSO₄) that is a conventional Co source. Also, manganese chloride used as an Mn source is substantially free from sulfur element unlike manganese sulfate (MnSO₄) that is a conventional Mn source. Use of these starting raw materials can prevent the sulfur element contamination resulting from the starting raw materials. Thereby, the sulfate ion concentration of the transition metal solution can be controlled to 0.9 mol/L or lower. The amount of sulfate (Na₂SO₄, etc.) precipitated in the precursor production step S30 can be significantly reduced by using this transition metal solution. As a result, the sulfate contamination level in the manufactured positive electrode active material can be decreased to improve the performance (initial resistance) of the lithium ion secondary battery.

Note that the phrase “a starting raw material substantially free from sulfur element is used” in this specification means that a compound containing sulfur element is not intentionally used as a starting raw material. Thus, if a small amount of sulfur element unavoidably contaminates the starting raw material due to the manufacturing process or the like, it is interpreted that “a starting raw material substantially free from sulfur element is used”. For example, when the content of sulfur element relative to the total weight (100 wt %) of the starting raw material is 1 wt % or less (preferably 0.1 wt % or less, more preferably 0.01 wt % or less, even more preferably 0.001 wt % or less, particularly preferably 0.0001 wt % or less), it can be said that “a starting raw material substantially free from sulfur element is used”. A transition metal solution with a sulfate ion concentration of 0.9 mol/L or lower can be easily formulated by using such a starting raw material.

The sulfate ion concentration of the transition metal solution is preferably 0.8 mol/L or lower, more preferably 0.7 mol/L or lower, even more preferably 0.6 mol/L or lower, particularly preferably 0.5 mol/L or lower. As the sulfate ion concentration of the transition metal solution decreases, the sulfate contamination level in the positive electrode active material decreases, and therefore a positive electrode active material with a higher performance can be manufactured. On the other hand, the lower limit value of the sulfate ion concentration of the transition metal solution may be 0 mol/L (no sulfate ion) without any particular limitation.

A ratio (M_{S}/M_{T}) between the total quantity of the transition metal elements (M_{T}) to the mass of sulfur elements (M_{S}) in the transition metal solution is preferably 0.5 or lower, more preferably 0.3 or lower, even more preferably 0.1 or lower, particularly preferably 0.01 or lower. Thereby, the amount of the sulfate that precipitates simultaneously with the positive electrode active material precursor (transition metal hydroxide) can be further decreased. As a result, the sulfate contamination level in the manufactured positive electrode active material can be more suitably decreased. On the other hand, the lower limit value of the M_{S}/M_{T} may be 0 or higher (M_{S}=0 mol/L) without any particular limitation.

### Other Embodiments

As described above, the first embodiment of the technology disclosed herein has been explained. The technology disclosed herein is not limited to the embodiment described above but includes other embodiments with variously-changed configurations. Other examples of embodiments of the technology disclosed herein will be explained below.

### (1) Type of Starting Raw Material

In the first embodiment, a used positive electrode active material (LNCM oxide) is used as an NiCo source, and manganese chloride (MnCl₂) is used as an Mn source. However, the manufacture method disclosed herein is not limited to the configuration using a specific starting raw material. Other examples of the starting raw material for providing Ni (Ni source) include nickel oxide, nickel carbonate, nickel acetate, nickel chloride, nickel hydroxide, and nickel nitrate. Other examples of the starting raw material for providing Co (Co source) include cobalt oxide, cobalt carbonate, cobalt acetate, cobalt chloride, cobalt hydroxide, and cobalt nitrate. Other examples of the starting raw material for providing Mn (Mn source) include manganese chloride, as well as manganese oxide, manganese carbonate, manganese acetate, manganese chloride, manganese hydroxide, and manganese nitrate. Since these starting raw materials are also substantially free from sulfur element, they facilitate formulation of a transition metal solution with a sulfate ion concentration of 0.9 mol/L or lower.

Furthermore, the technologies disclosed herein are not intended to prohibit use of sulfates (nickel sulfate, cobalt sulfate, manganese sulfate, etc.) as the starting raw material. In other words, if the sulfate ion concentration of the transition metal solution can be controlled to 0.9 mol/L or lower, sulfates may be partially used for the starting raw material. For example, when using a NiCo source (used positive electrode active material etc.) substantially free from sulfur element, sulfur element contamination caused by providing Ni and Co can be suppressed. If the positive electrode active material to be manufactured is an LNCM material with a low Mn content, the addition amount of the Mn source is smaller than the NiCo source. In such a case, even if a sulfate (manganese sulfate) is used as the Mn source, the sulfate ion concentration of the transition metal solution can be decreased to 0.9 mol/L or lower.

### (2) Sorting of Starting Raw Material

In the embodiment described above, the starting raw material with a known composition is used, and the sulfate ion concentration of the transition metal solution is controlled to 0.9 mol/L or lower. However, in the manufacture method disclosed herein, a material with an unknown composition (collected mineral, recycled material whose origin is unknown, etc.) can be used as a starting raw material. In this case, as illustrated in FIG. 2, a measurement step S12 and a raw material sorting step S14 should be conducted in the preparation step S10. Each step will be specifically explained below.

First, in the measurement step S12, a molar concentration of sulfur element in the starting raw material is measured. In this step, a conventionally known elemental analysis technology can be used without any particular limitation. Examples of this elemental analysis technology include an ICP analysis, a scanning electron microscope-energy dispersive X-ray spectroscopy (SEM-EDS) analysis, and an X-ray fluorescence (XRF) analysis. Next, in the raw material sorting step S14, the starting raw material with a sulfur element molar concentration lower than a predetermined threshold is sorted as a starting raw material to be provided in the formulation step S20. Thus, even when a starting raw material with an unknown detailed composition is used, the sulfate ion concentration of the transition metal solution can be sufficiently decreased. The threshold value set in the raw material sorting step S14 can be set as appropriate from the view point of controlling the sulfate ion concentration of the transition metal solution to 0.9 mol/L or lower.

The measurement step S12 and the raw material sorting step S14 illustrated in FIG. 2 may be conducted when using a starting raw material with a known composition. Thereby, the amount of sulfur element as an impurity contaminating the starting raw material can be grasped, so that the contamination of sulfur element resulting from the starting raw material can be more suitably suppressed. The measurement step S12 and the raw material sorting step S14 described above are not necessarily conducted for all of the starting raw materials for use. For example, the measurement step S12 and the raw material sorting step S14 should be conducted when the type or the lot of the starting raw material is changed, or when the condition of another step is changed. Thus, a positive electrode active material with a low sulfate contamination level can be manufactured without significantly decreasing the producibility.

### (3) Type of Extractant

In the first embodiment, ammonia water is used as an extractant for extracting Ni and Co from the NiCo raw material. Furthermore, water is used as an extractant for extracting Mn from the Mn raw material. However, the extractant used in the formulation step S20 can be selected from conventionally known extractants without any particular limitation as long as it can extract a desired transition metal element from the starting raw material. Other examples of this extractant include organic acids such as citric acid, ascorbic acid, oxalic acid, and acetic acid, and inorganic acids such as nitric acid, hydrochloric acid, phosphoric acid, and sulfuric acid. However, sulfuric acid can cause sulfur element to contaminate the transition metal solution. Thus, when using sulfuric acid as an extractant, the concentration of sulfuric acid and the type of the starting raw material must be adjusted as appropriate so that the sulfate ion concentration of the transition metal solution is 0.9 mol/L or lower.

### (4) Separation of Sulfur Element

In each of the above-described embodiments, the sulfuric acid ion concentration of the transition metal solution is controlled to 0.9 mol/L or lower by suppressing the sulfur element contamination resulting from the materials of the transition metal solution (starting raw material, extractant). However, in the technology disclosed herein, it is only necessary to control the sulfate ion concentration of the transition metal solution to 0.9 mol/L or lower during the precursor production step S30. That means, after formulating the transition metal solution with the sulfate ion concentration of higher than 0.9 mol/L in the formulation step S20, the sulfate ions may be removed from said transition metal solution. Even when such a configuration is adopted, the sulfate ion concentration of the transition metal solution can be controlled to 0.9 mol/L or lower to manufacture a positive electrode active material with a low sulfate contamination level. As a specific means of removing sulfate ions from the transition metal solution, calcium hydroxide should be added. Thus, sulfate ions can be removed calcium sulfate.

### (5) Type of Positive Electrode Active Material

In each of the above-described embodiments, a lithium-nickel-cobalt-manganese composite oxide is produced as the positive electrode active material. However, the technology disclosed herein is not limited to the type of the positive electrode active material to be manufactured. That means, the manufacture method disclosed herein also makes it possible to manufacture other lithium transition metal composite oxides (LN oxide, LC oxide, LNM oxide, LMC oxide, LNC oxide, etc.).

### Test Examples

Test examples related to the technology disclosed herein will be explained below. The contents of the test examples described below are not intended to limit the technology disclosed herein.

### 1. Sample Preparation

In this test, three types of positive electrode active materials were prepared by different manufacture procedures. A manufacture procedure for each example will be explained below.

### (1) Example 1

In Example 1, a transition metal sulfate was prepared as the starting raw material. Specifically, nickel sulfate hexahydrate (NiSO₄·6H₂O) was prepared as an Ni source. A cobalt sulfate heptahydrate (CoSO₄·7H₂O) was prepared as a Co source. A manganese sulfate pentahydrate (MnSO₄·5H₂O) was prepared as an Mn source.

Subsequently, a transition metal sulfate is dissolved in water to formulate a transition metal solution. In this step, the addition amount of the starting raw material was adjusted so that the transition metal element concentration in the solution was 1.5 mol/L. The mixing ratio of the Ni source, Co source, and Mn source was adjusted so that Ni:Co:Mn is 8:1:1.

Subsequently, a reaction vessel containing 0.5 wt % NH₃ water was prepared, to which the transition metal solution, 28 wt % NH₃ water, and 30 wt % NaOH aqueous solution were continuously dripped while maintaining the temperature of the reaction vessel at 40° C. and stirring the mixture at 600 rpm. To the mixture, the transition metal solution and the NaOH aqueous solution were continuously dripped for 6 hours while adjusting the addition amount of the NaOH aqueous solution so that a pH in the reaction vessel was maintained at 11.4. Then, a solid content precipitated in the reaction vessel was collected by solid-liquid separation. The collected solid content was washed twice with water and then dried. The NiCoMn hydroxide obtained as described above was used as a positive electrode active material precursor.

Subsequently, the positive electrode active material precursor was mixed with lithium hydroxide (LiOH) to prepare a mixed material. In this step, the mixing ratio of each material was adjusted so that the molar ratio between lithium and the transition metal elements was 1.06:1. The mixed material was then subjected to a baking treatment. The conditions of the baking treatment were set such that the maximum temperature was 800° C., a baking time was 5 hours, and a baking atmosphere was oxygen atmosphere, to manufacture an LNCM oxide (positive electrode active material).

### (2) Example 2

In Example 2, first, the used positive electrode active material (LNCM oxide, Ni:Co:Mn=8:1:1) was baked (baking temperature: 650° C., baking time: 5 hours, baking atmosphere: oxygen atmosphere). This baked positive electrode active material was used as an NiCo source. This positive electrode active material was immersed in an NH₃ solution to exude NiCo in the positive electrode active material. For the NH₃ solution, a mixed solution containing 28 wt % of NH₃, 0.5 mol/L of (NH₄)₂SO₄, and 0.5 mol/L of H₂O₂ was used. In the NH₃ immersion treatment, the positive electrode active material was immersed in the NH₃ solution maintained at 80° C. for 8 hours while stirring at 500 rpm. Then, the solid content was removed by solid-liquid separation to obtain a solution containing Ni and Co (NiCo solution). Subsequently, manganese sulfate pentahydrate (MnSO₄·5H₂O) was added to this NiCo solution so that the total concentration of the transition metal elements was 1.5 mol/L to formulate a transition metal solution containing Ni, Co, and Mn. In Example 2, after the positive electrode active material precursor was crystallized from the transition metal solution, the LNCM oxide (positive electrode active material) was manufactured using the positive electrode active material precursor, according to the same procedure as in Example 1.

### (3) Example 3

In Example 3, the baking treatment and the NH₃ exudation were performed under the same condition as in Example 2 except that an LiNi composite oxide was used as the used positive electrode active material. Thereby, only Ni was extracted from the used positive electrode active material. Subsequently, cobalt sulfate heptahydrate (CoSO₄·7H₂O) and manganese sulfate pentahydrate (MnSO₄·5H₂O) were added to this Ni solution to formulate a transition metal solution containing Ni, Co and Mn. Thus, also in Example 3, an LNCM oxide (positive electrode active material) was manufactured according to the same procedure as in Example 1.

### 2. Evaluation Test

### (1) Measurement of Sulfur Contamination Level

A portion of the transition metal solution was collected during the fabrication in Examples 1 to 3, and an amount of sulfur element was measured using ICP analysis. Then, a sulfate ion concentration (mol/L) of the transition metal solution was calculated based on the measurement result. In this test, an amount of sulfate in the manufactured LNCM oxide was also measured. In this measurement of the sulfate amount, the LNCM oxide was dissolved in nitric acid to formulate a solution. This solution was subjected to ICP analysis to measure an amount of sulfur element. A sulfate ion concentration in the positive electrode active material was calculated based on the amount of sulfur element as the measurement result. Each result is presented in Table 1.

### (2) Fabrication of Lithium Ion Secondary Battery

Subsequently, lithium ion secondary batteries were prepared using the positive electrode active materials in Examples 1 to 3. Herein, a positive electrode active material, a conductive material (black lead), binding material (polyvinylidene fluoride powder), and N-methyl-2-pyrrolidone (NMP) were mixed to formulate a positive electrode composite slurry. The mixing ratio of each raw material was set so that a ratio of the conductive material was 1 part by mass and a ratio of the binding material was 0.9 part by mass based on the positive electrode active material (100 parts by mass). Next, the positive electrode composite slurry was applied to both sides of a positive electrode current collector (aluminum foil) and dried. The dried coating film was then rolled with a roller to fabricate a positive electrode with positive electrode active material layers formed on both sides of the positive electrode current collector.

Next, a negative electrode with negative electrode active material layers formed on both sides of a negative electrode current collector (copper foil) was fabricated. The negative electrode active material layer was made of a mixture of a negative electrode active material (graphite), a binder (styrene-butadiene rubber), and a thickener (carboxymethyl cellulose). The mixing ratio of the negative electrode active material, the binder, and the thickener was set to 98:1:1. A porous membrane having a three-layer structure of PP/PE/PP was also prepared as a separator. Then, a wound electrode body was fabricated using the positive electrode, the negative electrode, and the separator. Electrode terminals were attached to the wound electrode body, which was accommodated in an aluminum battery case. Next, the battery case was filled with a nonaqueous electrolytic solution to fabricate a lithium ion secondary battery for evaluation. In this test, 1.0 mol/L of LiPF₆ was added to a mixed solvent containing ethylene carbonate (EC), dimethyl carbonate (DMC), and ethylmethyl carbonate (EMC) in a volume ratio of 3:4:3, and this mixture was used as the nonaqueous electrolytic solution.

### (3) Evaluation of Power Output Property

The battery for evaluation was charged to half of its initial capacity at a constant current of 0.5 It under a temperature environment of 25° C. The charging was stopped and the battery was left for 15 minutes, then a voltage was measured when the battery was charged at a constant current of 0.1 It for 10 seconds. Subsequently, the 10 second-charge capacity was discharged, then the current value was changed and the battery was charged, and a voltage at this time was measured. Then, the 10 second-charge capacity was discharged. The above-described charge/discharge cycle was repeated at current values ranging from 0.1 It to 2 It. The initial resistance was measured based on the measured voltage and current values. The results are presented in Table 1. The initial resistances in Table 1 are represented by ratios based on 100% of the initial resistance of Example 1.

TABLE 1

| | | | | Sulfate ion | | |
|---|---|---|---|---|---|---|
| | | | | concentration | Chloride in | |
| | Starting raw material | | | of transition | positive | Initial |
| | Ni | Co | Mn | metal solution | electrode active | resistance |
| | source | source | source | (mol/L) | material (wt %) | (%) |
| Example 1 | Sulfate | Sulfate | Sulfate | 1.5 | 1.4 | 100 |
| Example 2 | LNCM | LNCM | Sulfate | 0.7 | 0.3 | 92 |
| | oxide | oxide | | | | |
| Example 3 | LNCM | Sulfate | Sulfate | 0.9 | 0.6 | 95 |
| | oxide | | | | | |

As presented in Table 1, it was found that the sulfate ion concentration of the transition metal solution was decreased by using the LNCM oxide for a portion of the starting raw material. Also, it was found that the sulfate contamination level in the positive electrode active material could be decreased by controlling the sulfate ion concentration of the transition metal solution to 0.9 mol/L or lower. As presented in Examples 2 and 3, it was confirmed that, in the positive electrode active material with a low sulfate contamination level, the initial resistance of the lithium ion secondary battery could be decreased by as much as 5% or higher.

As described above, the technologies disclosed herein have been explained in detail, but these technologies are merely examples and are not intended to limit claims. The technologies described in claims include various variations and modifications of the specific examples illustrated above. That means, the technologies disclosed herein encompass configurations described in the following items 1 to 5.

### <Item 1>

A method for manufacturing a positive electrode active material, including:
preparing a starting raw material containing at least a transition metal element;
formulating a transition metal solution by dissolving, in an extractant, the transition metal element in the starting raw material;
crystallizing a positive electrode active material precursor by adding an alkali solution to the transition metal solution; and
producing a positive electrode active material by heating the positive electrode active material precursor together with a lithium compound, wherein
a sulfate ion concentration of the transition metal solution is 0.9 mol/L or lower during the crystallizing a positive electrode active material precursor.

### <Item 2>

The method according to Item 1, in which the starting raw material contains at least Ni and/or Co.

### <Item 3>

The method according to Item 1 or 2, in which the starting raw material is a positive electrode active material for a used lithium ion secondary battery.

### <Item 4>

The method according to any one of Items 1 to 3, in which
the preparing a starting raw material comprises:
measuring a sulfur element molar concentration in the starting raw material; and
sorting a starting raw material with the sulfur element molar concentration lower than a predetermined threshold as a starting raw material to be provided to the formulation step.

### <Item 5>

The method according to any one of Items 1 to 4, in which the extractant is at least one selected from a group consisting of ammonia water, citric acid, ascorbic acid, oxalic acid, acetic acid, nitric acid, hydrochloric acid, phosphoric acid, and sulfuric acid.

What is claimed is:

1. A method for manufacturing a positive electrode active material, comprising:
preparing a starting raw material containing at least a transition metal element;
formulating a transition metal solution by dissolving, in an extractant, the transition metal element in the starting raw material;
crystallizing a positive electrode active material precursor by adding an alkali solution to the transition metal solution; and
producing a positive electrode active material by heating the positive electrode active material precursor together with a lithium compound, wherein
a sulfate ion concentration of the transition metal solution is 0.9 mol/L or lower during the crystallizing a positive electrode active material precursor.

2. The method according to claim 1, wherein the starting raw material contains at least Ni and/or Co.

3. The method according to claim 2, wherein the starting raw material is a positive electrode active material for a used lithium ion secondary battery.

4. The method according to claim 1, wherein
the preparing a starting raw material comprises:
measuring a sulfur element molar concentration in the starting raw material; and
sorting a starting raw material with the sulfur element molar concentration lower than a predetermined threshold as a starting raw material to be provided to the formulation step.

5. The method according to claim 2, wherein
the preparing a starting raw material comprises:
measuring a sulfur element molar concentration in the starting raw material; and
sorting a starting raw material with the sulfur element molar concentration lower than a predetermined threshold as a starting raw material to be provided to the formulation step.

6. The method according to claim 3, wherein
the preparing a starting raw material comprises:
measuring a sulfur element molar concentration in the starting raw material; and
sorting a starting raw material with the sulfur element molar concentration lower than a predetermined threshold as a starting raw material to be provided to the formulation step.

7. The method according to claim 1, wherein the extractant is at least one selected from a group consisting of ammonia water, citric acid, ascorbic acid, oxalic acid, acetic acid, nitric acid, hydrochloric acid, phosphoric acid, and sulfuric acid.

8. The method according to claim 6, wherein the extractant is at least one selected from a group consisting of ammonia water, citric acid, ascorbic acid, oxalic acid, acetic acid, nitric acid, hydrochloric acid, phosphoric acid, and sulfuric acid.
